(19) United States
(12) Patent Application Publication
(10) Pub. No.: US 2025/0329186 A1
(43) Pub. Date: Oct. 23, 2025

(54) IMAGE PROCESSING APPARATUS

(71) Applicant: KYOCERA Document Solutions Inc., Osaka (JP)

(72) Inventor: Issei Hayashi, Osaka (JP)

(21) Appl. No.: 19/184,248

(22) Filed: Apr. 21, 2025

(30) Foreign Application Priority Data
Apr. 22, 2024 (JP) 2024-068796

(51) Int. Cl. G06V 30/416; G06F 40/58; G06T 11/60

(52) U.S. Cl. CPC G06V 30/416; G06F 40/58; G06T 11/60

(57) ABSTRACT

A character recognition processing unit performs a character recognition process for a document image and thereby acquires text data in an original language for each chapter, and determines a character area of the text data in the original language for each chapter. A translation processing unit acquires translated text data. A character removing unit removes a text in the original language in the character area. A character depicting unit determines whether a text based on the translated text data (translated text) fits the character area or not for each chapter, and if the translated text does not fit the character area, when the chapter is of a single line, expands the character area and attaches the translated text to the character area and when the chapter is of plural lines, decreases a character size of the translated text and attaches the translated text to the character area.

### CROSS-REFERENCE TO RELATED APPLICATIONS

This application relates to and claims priority rights from Japanese Patent Application No. 2024-068796, filed on Apr. 22, 2024, the entire disclosures of which are hereby incorporated by reference herein.

### BACKGROUND

### 1. FIELD OF THE PRESENT DISCLOSURE

The present disclosure relates to an image processing apparatus.

### 2. DESCRIPTION OF THE RELATED ART

An image processing system (a) performs a character recognition process for a document image and thereby acquires text data, (b) performs a translation process for the text data and thereby acquires translated text data, and (c) if a text (translated text) based on the translated text data does not fit an area to which the text should be attached, decreases a size of the text or expands the area.

However, in the aforementioned system, if a translated text does not fit an area to which the translated text should be attached, a size of the text is always decreased or the area is always expanded, and consequently a layout of the document image is disturbed in some cases.

### SUMMARY

An image processing apparatus according to an aspect of the present disclosure includes a document image acquiring unit, a character recognition processing unit, a translation processing unit, a layout analyzing unit, a character removing unit, and a character depicting unit. The document image acquiring unit is configured to acquire a document image. The character recognition processing unit is configured to perform a character recognition process for the document image and thereby acquire text data in an original language for each chapter, and determine a character area of the text data in the original language for each chapter. The translation processing unit is configured to acquire translated text data corresponding to the text data in the original language. The layout analyzing unit is configured to classify the chapter into a chapter of a single line and a chapter of plural lines. The character removing unit is configured to remove a text in the original language in the character area. The character depicting unit is configured to (a) determine whether a text based on the translated text data fits the character area or not for each chapter, (b) if the text based on the translated text data fits the character area, attach the text based on the translated text data to the character area, and (c) if the text based on the translated text data does not fit the character area, when the chapter is a chapter of a single line, expand the character area such that the text based on the translated text data fits the expanded character area and attach the text based on the translated text data to the expanded character area and when the chapter is a chapter of plural lines, decrease a character size of the text based on the translated text data such that the text based on the translated text data fits the expanded character area and attach the text based on the translated text data to the character area.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image processing apparatus according to an embodiment of the present disclosure;

FIG. 2 shows a diagram that indicates an example of a document image;

FIGS. 3A and 3B show diagrams that explain a chapter of a single line and a chapter of a plural lines;

FIGS. 4A and 4B show diagrams that explain expansion of a character area;

FIG. 5 shows a flow chart that explains a behavior of the image processing apparatus in Embodiment 1; and

FIG. 6 shows a diagram that indicates an example of a document image that includes a formula.

### DETAILED DESCRIPTION

Hereinafter, embodiments according to an aspect of the present disclosure will be explained with reference to drawings.

### Embodiment 1

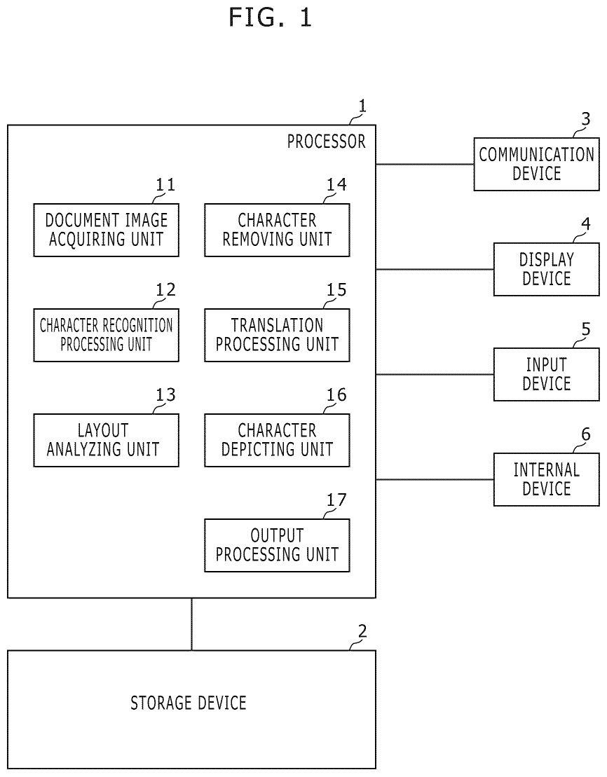

FIG. 1 shows a block diagram that indicates a configuration of an image processing apparatus according to an embodiment of the present disclosure. An image processing apparatus shown: in FIG. 1 is an information processing apparatus such as personal computer, or an electronic apparatus such as digital camera or image forming apparatus (scanner, multi function peripheral or the like), and includes a processor 1, a storage device 2, a communication device 3, a display device 4, an input device 5, an internal device 6 and the like.

The processor 1 includes a computer, and executes a program with the computer and thereby, acts as sorts of processing units. Specifically, the computer includes a CPU (Central Processing Unit), a ROM (Read Only Memory), a RAM (Random Access Memory) and the like, loads a program stored in the ROM or the storage device 2, executes the program with the CPU, and thereby acts as sorts of processing units. Further, the processor 1 may include an ASIC (Application Specific Integrated Circuit) that acts as a specific processing unit.

The storage device 2 is a non-volatile storage device such as flash memory, and stores the image processing program and data required for a process mentioned below. In the storage device 2, setting data and the like are stored.

The communication device 3 is a device that performs data communication with an external device, such as network interface or peripheral device interface. The display device 4 is a device that displays sorts of information to a user, such as a display panel of a liquid crystal display. The input device 5 is a device that detects a user operation, such as keyboard or touch panel.

The internal device 6 is a device that performs a specific function of this image processing apparatus. For example, if this image processing apparatus is an image forming apparatus, the internal device 6 is an image scanning device that optically scans a document image from a document, a printing device that prints an image on a print sheet, and/or the like.

Here, the processor 1 acts as a document image acquiring unit 11, a character recognition processing unit 12, a layout analyzing unit 13, a character removing unit 14, a translation processing unit 15, a character depicting unit 16, and an output processing unit 17.

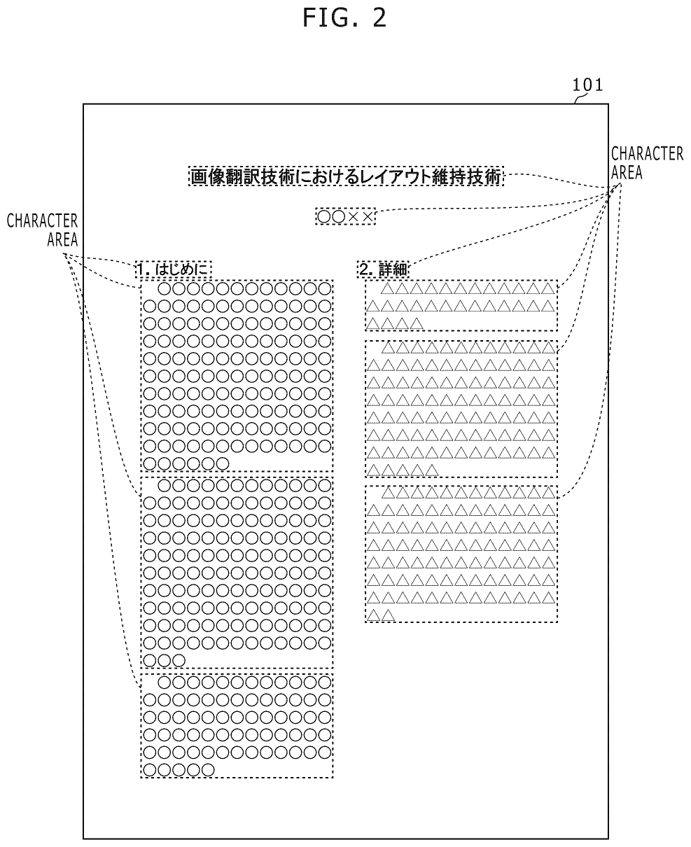

The document image acquiring unit 11 acquires a document image (i.e. image data of it) of a document from the storage device 2, the communication device 3, the internal device 6 or the like, and stores the document image into the RAM. For example, this document is a print product outputted by a printing device, and this document image is an image obtained by optically scanning such document using an image scanning device. This document is an article or the like, for example. FIG. 2 shows a diagram that indicates an example of a document image. The document image 101 shown in FIG. 2 includes a text of plural chapters (paragraphs or the like).

The character recognition processing unit 12 performs a character recognition process for the document image 101 and thereby acquires text data in an original language for each chapter, and determines a character area of the text data in the original language for each chapter. The character area is a bounding box of a text of each chapter and is a rectangular area, of which coordinate values of two vertices opposite to each other on a diagonal are determined and stored.

The layout analyzing unit 13 classifies the determined chapter into a chapter of a single line and a chapter of plural lines.

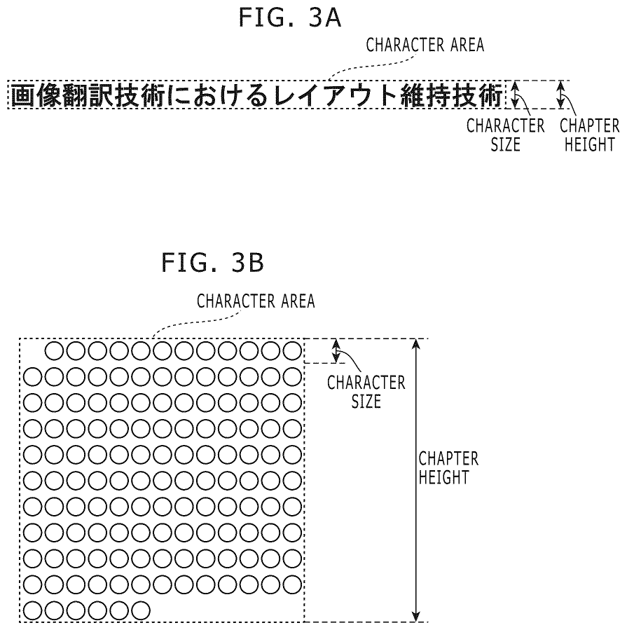

FIGS. 3A and 3B show diagrams that explain a chapter of a single line and a chapter of a plural lines. Specifically, as shown in FIGS. 3A and 3B, for example, for each of the determined chapters, the layout analyzing unit 13 determines a chapter height (i.e. a height of the character area) and a character size (i.e. a line height); and as shown in FIG. 3A, for example, if the both agrees with each other, the layout analyzing unit 13 determines that this chapter is a chapter of a single line, and as shown in FIG. 3B, for example, if the chapter height is larger than the line height, the layout analyzing unit 13 determines that this chapter is a chapter of plural lines. The chapter height and the line height (i.e. character height) are determined by the character recognition processing unit 12.

The character removing unit 14 removes a text in the original language in the determined character area in the document image 101.

The translation processing unit 15 acquires translated text data corresponding to the aforementioned text data in the original language. The translation processing unit 15 may perform a translation process for the aforementioned text data in the original language in an existing manner and thereby acquire the text data translated to another language, or may access an external server that performs a translation process using the communication device 3 and acquire the translated text data with the external server. Here, in the translation process, translation from Japanese to English is performed. Alternatively, translation between other languages may be performed in the translation process.

The character depicting unit 16 (a) determines whether a text based on the translated text data fits the character area (i.e. the character area of the corresponding text data in the original language) or not for each chapter, and (b) if the text based on the translated text data fits the character area, attaches the text based on the translated text data to the character area.

Specifically, the character depicting unit 16 (a) sets a default character size (e.g. font point size) of the text based on the translated text data such that a default character height of the text based on the translated text data agrees with a character height of the text in the original language, and (b) determines whether the text based on the translated text data with the default character size fits the character size or not for each chapter. The number of characters in the text changes through the translation, the translated text may not fit the character area.

Contrarily, if the text based on the translated text data does not fit the character area, then (a) when the chapter is a chapter of a single line, the character depicting unit 16 expands the character area such that the text based on the translated text data fits the expanded character area and attaches the text based on the translated text data to the expanded character area and (b) when the chapter is a chapter of plural lines, the character depicting unit 16 decreases a character size of the text based on the translated text data such that the text based on the translated text data fits the expanded character area and attaches the text (of the decreased character size) based on the translated text data to the character area.

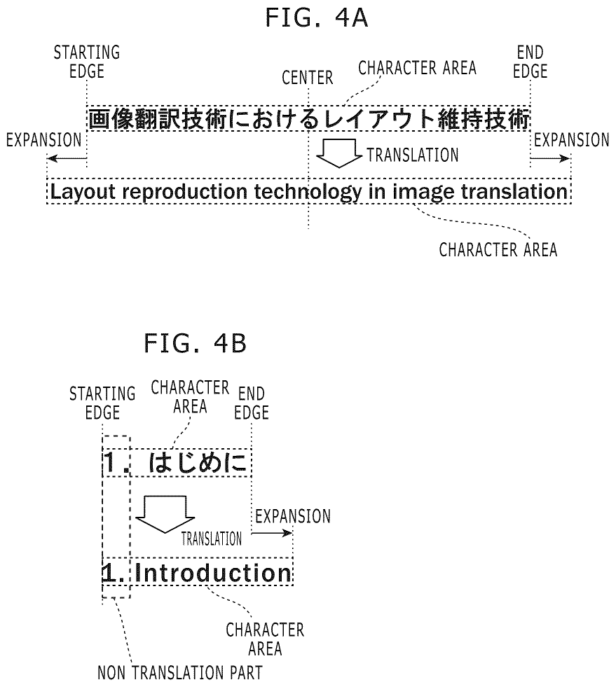

FIGS. 4A and 4B show diagrams that explain expansion of a character area. Specifically, when the character area should be expanded, the character depicting unit 16 (a) determines whether there is a non translation part (numeral, symbol or the like) at at least one of a starting edge and an end edge of the text data of the chapter or not, and (b) if it is determined that there is not the non translation part as shown in FIG. 4A, for example, the character depicting unit 16 expands the character area in both directions of the starting edge and the end edge, and if it is determined that there is the non translation part as shown in FIG. 4B, for example, the character depicting unit 16 does not expand the character area in a direction of the non translation part and expands the character area in a direction of either the starting edge or the end edge that the non translation part does not exist.

The output processing unit 17 performs outputting (printing, data transmission, data saving and/or the like) of a translated document image (i.e. a document image in which the text based on the translated text data has been attached to the character area that the text in the original language has been removed).

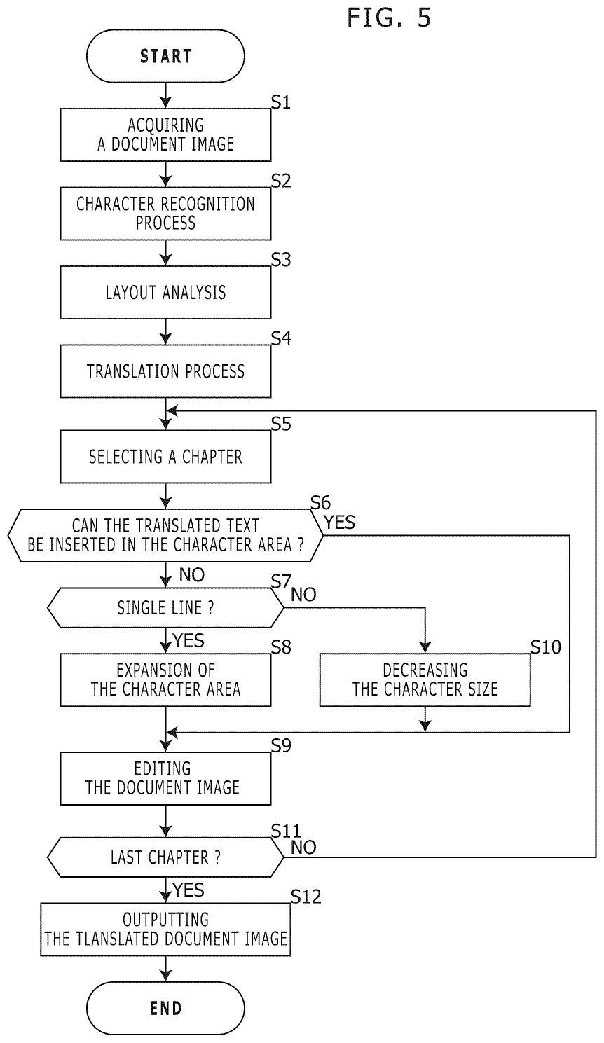

The following part explains a behavior of the image processing apparatus in Embodiment 1. FIG. 5 shows a flow chart that explains a behavior of the image processing apparatus in Embodiment 1.

Firstly, the document image acquiring unit 11 acquires image data of a document image 101 from the storage device 2, the communication device 3, the internal device 6 or the like (in Step S1). The character recognition processing unit 12 performs a character recognition process for the document image 101 and thereby acquires text data in an original language for each chapter, and determines a character area of the text data in the original language for each chapter (in Step S2).

The layout analyzing unit 13 classifies the determined chapters into a chapter of a single line and a chapter of plural lines (in Step S3). Further, the translation processing unit 15 acquires translated text data corresponding to the aforementioned text data in the original language (in Step S4).

Meanwhile, the character removing unit 14 removes the text in the original language in the determined character area in the document image 101.

The character depicting unit 16 selects a chapter (that has not been selected) among the determined plural chapters in the document image 101 (in Step S5), and determines whether the text based on the translated text data (i.e. translated text) fits the character area of the corresponding text data in the original language or not (in Step S6).

If it is determined that the text based on the translated text does not fit the character area, then the character depicting unit 16 determines whether this chapter is a chapter of a single line or not (in Step S7).

If it is determined that this chapter is a chapter of a single line, the character depicting unit 16 expands the character area in the aforementioned manner (in Step S8), and attaches an image of the translated text to the expanded character area (in Step S9).

Contrarily, if this chapter is not a chapter of a single line (i.e. if this chapter is a chapter of plural lines), the character depicting unit 16 does not expand the character area and decreases the character size from the default character size (in Step S10), and attaches an image of the translated text (of which the character size has been decreased) to the character area (in Step S9).

Subsequently, the character depicting unit 16 determines whether this chapter is the last chapter in the document image 101 or not (in Step S11), and if this chapter is not the last chapter, returning to Step S5, selects a next chapter and performs the subsequent processes as well. Contrarily, if this chapter is the last chapter, then the translation is terminated, and the output processing unit 17 performs outputting of the image data of the translated document image 101 (in Step S12).

As mentioned, in Embodiment 1, the character recognition processing unit 12 performs a character recognition process for a document image and thereby acquires text data in an original language for each chapter, and determines a character area of the text data in the original language for each chapter. The character depicting unit 16 determines whether a text based on the translated text data (translated text) fits the character area or not for each chapter, and if the text based on the translated text data does not fit the character area, when the chapter is a chapter of a single line, expands the character area such that the text based on the translated text data fits the expanded character area and attaches the text based on the translated text data to the expanded character area and when the chapter is a chapter of plural lines, decreases a character size of the text based on the translated text data such that the text based on the translated text data fits the expanded character area and attaches the text based on the translated text data to the character area.

Consequently, a size of a single-line chapter such as document title or chapter title is not improperly reduced, and therefore, restrained is disturbance of a layout of the document image due to replacement of the text in the original language with the translated text.

### Embodiment 2

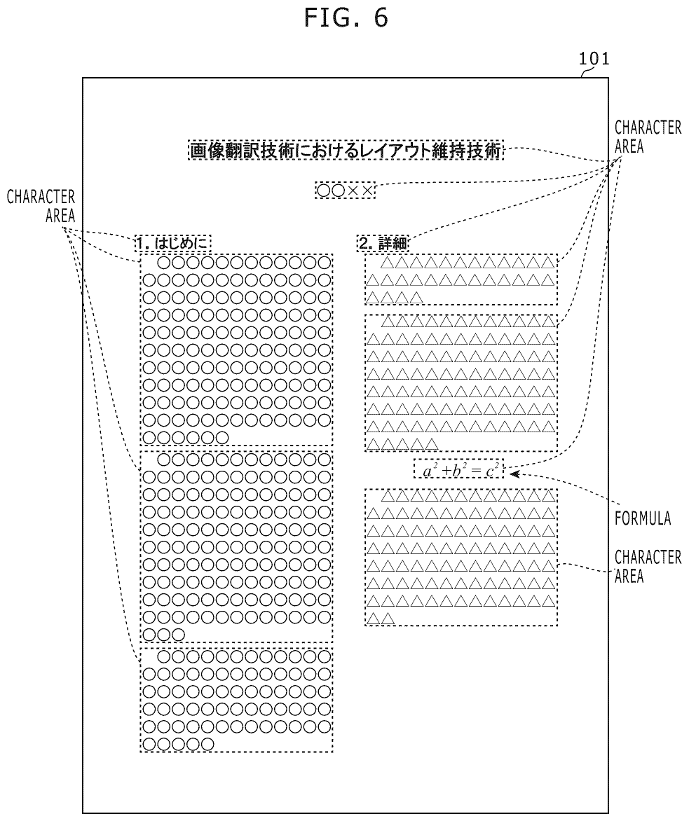

FIG. 6 shows a diagram that indicates an example of a document image that includes a formula.

In Embodiment 2, the character recognition processing unit 12 detects text data of a formula among the text data in the original language. Specifically, the character recognition processing unit 12 determines whether text data of a chapter of a single line is text data of a formula or not, and thereby detects text data of a formula.

If text data of a formula is detected among the text data in the original language, (a) the translation processing unit 15 does not acquire translated text data corresponding to the text data of the formula, (b) the character removing unit 14 does not remove a text in the original language corresponding to the text data of the formula, and (c) the character depicting unit 16 does not attach to the character area a text based on translated text data corresponding to the text data of the formula.

As mentioned, regarding a formula included in the document image 101, the translation is not performed and the original formula is left as is in the translated document image.

Other parts of the configuration and behaviors of the image processing apparatus in Embodiment 2 are identical or similar to those in Embodiment 1, and therefore not explained here.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image processing apparatus, comprising:
a document image acquiring unit configured to acquire a document image;
a character recognition processing unit configured to perform a character recognition process for the document image and thereby acquire text data in an original language for each chapter, and determine a character area of the text data in the original language for each chapter;
a translation processing unit configured to acquire translated text data corresponding to the text data in the original language;
a layout analyzing unit configured to classify the chapter into a chapter of a single line and a chapter of plural lines;
a character removing unit configured to remove a text in the original language in the character area; and
a character depicting unit configured to (a) determine whether a text based on the translated text data fits the character area or not for each chapter, (b) if the text based on the translated text data fits the character area, attach the text based on the translated text data to the character area, and (c) if the text based on the translated text data does not fit the character area, when the chapter is a chapter of a single line, expand the character area such that the text based on the translated text data fits the expanded character area and attach the text based on the translated text data to the expanded character area and when the chapter is a chapter of plural lines, decrease a character size of the text based on the translated text data such that the text based on the translated text data fits the expanded character area and attach the text based on the translated text data to the character area.

2. The image processing apparatus according to claim 1, wherein the character depicting unit (a) sets a default character size of the text based on the translated text data such that a default character height of the text based on the translated text data agrees with a character height of the text in the original language, and (b) determines whether the text based on the translated text data with the default character size fits the character size or not for each chapter.

3. The image processing apparatus according to claim 1, wherein the character depicting unit (a) determines whether there is a non translation part at at least one of a starting edge and an end edge of the text data of the chapter or not when the character area is expanded, (b) if it is determined that there is the non translation part, does not expand the character area in a direction of the non translation part and expands the character area in a direction of either the starting edge or the end edge that the non translation part does not exist, and if it is determined that there is not the non translation part, expands the character area in both directions of the starting edge and the end edge.

4. The image processing apparatus according to claim 1, wherein the character recognition processing unit detects text data of a formula among the text data in the original language;
the translation processing unit does not acquire translated text data corresponding to the text data of the formula;
the character removing unit does not remove a text in the original language corresponding to the text data of the formula; and
the character depicting unit does not attach to the character area a text based on translated text data corresponding to the text data of the formula.
